(19) United States
(12) Patent Application Publication
(10) Pub. No.: US 2009/0279386 A1
(43) Pub. Date: Nov. 12, 2009

(54) METHOD FOR DETERMINING ADEQUACY OF SEISMIC DATA COVERAGE OF A SUBSURFACE AREA BEING SURVEYED

(76) Inventor: David MONK, Sugar Land, TX (US)

Correspondence Address: DEWIPAT INCORPORATED, P.O. BOX 1017, CYPRESS, TX, 77410-1017, US

(21) Appl. No.: 12/116,373

(22) Filed: May 7, 2008

(51) Int. Cl. G01V 1/38

(52) U.S. Cl. 367/21

(57) ABSTRACT

A method for assessing data coverage in a three dimensional marine seismic survey includes determining at least one Fresnel zone for at least one of a plurality of seismic data traces. A contribution is determined for each of the seismic data traces to each one of a set of bins in a defined pattern. Each contribution is based on the Fresnel zone associated with each seismic data trace. The contributions from all seismic data traces contributing to each bin are summed. The summed contribution for each bin are stored or displayed and the summed contributions in each bin are compared to a selected threshold to determine coverage.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of seismic surveying of the Earth's subsurface. More specifically, the invention relates to methods for determining whether seismic data have been acquired to sufficient spatial density to avoid distortions in generating images of the Earth's subsurface from seismic data.

2. Background Art

In seismic surveying, seismic energy sources are used to generate a seismic signal that propagates into the earth and is at least partially reflected by subsurface seismic reflectors. Such seismic reflectors typically are located at the interfaces between subterranean formations having different acoustic properties, specifically differences in acoustic impedance at the interfaces. The reflections are detected by seismic receivers at or near the surface of the earth, in an overlying body of water, or at known depths in boreholes. The resulting seismic data may be processed to yield information relating to the geologic structure and properties of the subterranean formations and their potential hydrocarbon content.

A purpose for various types of seismic data processing is to extract from the data as much information as possible regarding the subterranean formations. In order for the processed seismic data to accurately represent geologic subsurface properties, the reflection amplitudes need to be represented accurately. Non-geologic effects can cause the measured seismic amplitudes to deviate from the amplitude caused by the reflection from the geologic target. Amplitude distortions resulting from irregular distribution of source and receiver positions during data acquisition is a particularly troublesome non-geologic effect. If uncorrected, these non-geologic effects can distort the seismic image and obscure the geologic picture.

A seismic energy source generates an acoustic wave that reflects from or “illuminates” a portion of reflectors at different depths in the subsurface. In a three-dimensional (3D) survey, seismic signals are generated at a large number of source locations, detected at a large number of receiver locations and the survey generally illuminates large areas of the reflectors. U.S. Patent Application Publication No. 2006/0268662 filed by Rekdal et al. describes certain data density issues concerning marine seismic data. According to Rekdal et al, processing techniques known in the art including prestack 3D migration algorithms can produce good images of the sub-surface horizons only if the surface distribution of sources and receivers is relatively uniform. In practice, there are typically irregularities in the distribution of sources and receivers. Obtaining perfectly regular acquisition geometry is typically impracticable. Consequently, according to Rekdal et al., prestack 3D migrated seismic images often include non-geologic artifacts. Such artifacts can interfere with the interpretation of the seismic image and attribute maps.

It is well known in the art that in marine seismic surveys, the sensor cables or “streamers” do not form straight lines behind the vessel which tows the streamers. Typically marine currents cause the streamers to be displaced laterally, a phenomenon called “feathering.” Changes in marine currents often cause changes in the feathering. In such circumstances, if the planned sail line (direction of motion) separation of the seismic vessel is maintained, then feathering will lead to coverage “holes” at some offsets or offset ranges,. The term “coverage hole” as used by Rekdal et al. refers to a surface area where, for a given offset (source to sensor distance) or offset range, there are believed to be inadequately sampled data recorded. Data are defined to be “located” at the surface midpoint positions between the seismic source and seismic sensor positions at the time of acquisition of a seismic signal recording. Such coverage holes can vary in size, irregularity, and density of data remaining in the hole. It is possible to have holes where no data is present. Coverage holes may be of several kilometers extension in the sail line (inline) direction where streamers have feathered in the same direction for a long continuous length of the intended sail line, but are generally smaller in the crossline direction (orthogonal to the sail line), as this width is governed by the amount of feathering of the streamers.

In marine seismic streamer surveys, if data density criteria known in the art are used, portions of the subsurface may be believed to be inadequately covered with seismic data recordings due to cable feathering and other causes. Thus, using such prior art seismic data density evaluation criteria, it may be believed that additional passes of the seismic vessel through the prospect survey area are required. Additional “sail-lines” (passes of the vessel and streamers through the survey area) were also thought to be needed by reason of steering the vessel to achieve acceptable coverage. That means that the lateral distance between streamer positions in all the passes made by the vessel can be on average less than in the original acquisition plan. These additional passes significantly increase the time and associated cost to complete a survey. These additional passes of the survey vessel are referred to as “infill shooting” or just “infill.” A large portion of marine seismic data collection can be devoted to infill shooting because of perceived inadequacy of data density. The infill shooting may take up to several weeks or even months to complete. Thus, it is not uncommon to spend 15-30% of total acquisition costs on infill acquisition.

According to Rekdal et al, the maximum data hole sizes that will provide acceptable subsurface coverage are typically determined prior to acquisition, and are typically independent of local factors such as geology and survey objectives. Criteria for a seismic survey, such as acceptable subsurface coverage, are commonly called “infill specifications.” An object of the method described in the Rekdal et al. publication is to determine whether the coverage holes are of sufficient size to require infill acquisition.

The method disclosed in the Rekdal et al. publication makes use of certain assumptions about the required degree of data coverage based in part on substantially discontinued seismic data processing procedures. Such procedures, for example, consisted of “binning” the acquired seismic data, summing or “stacking” seismic data within each bin, and then migrating the data post stack. The requirements for migration in such processing are that each of the stack traces reasonably represents the same sum of a set of offset traces at each location. In order that the stack trace have similar properties at each location associated with a bin, it is important that it be the sum of a set of similar “offset” (distance between the seismic source and receiver) traces.

To ensure such similarity, traces are summed over a small area (a “bin”) such that a contribution from each of the expected offset traces is present in the sum. There are several problems with such procedure. First, the traces are summed over an area. Even if normal moveout (“NMO”) has been correctly performed, in the presence of reflective horizon “dip” (change in depth with respect to position), the reflective event times will not be aligned. This is often referred to as “bin smear”, and results in the loss of high frequency data content for dipping reflective events. Second, if a trace at a particular offset is missing, then either new data should be acquired (Infill data), or the bin can be expanded (overlapped into adjacent areas) to see whether a suitable trace is available. Such bin “flexing” obviously increases the “bin smear”, but if only a small number of traces are used, this may not be a large problem. If an acceptable trace is found, then it is copied into the required bin and may therefore now contribute to more than one stacked trace.

Some bins may contain more than one trace of the required offset. In order to keep the stack trace balance similar at all bin locations, extra traces in any such bin are not used. There are several criteria for which trace of a plurality of traces in a bin should be used, but most commonly the trace that is selected is the one having a position closest to the position of the bin center, as this potentially reduces the bin smear. However, such procedure means that some of the traces that have been acquired may be discarded from further processing.

It is currently common in seismic data acquisition, as explained above with reference to the Rekdal et al. publication, to make decisions on whether infill data should be acquired based on an evaluation of what traces fall in each bin of the survey. A procedure known as “flex binning” may be performed (typically in real time during acquisition) to infill “holes” where some offsets are missing from certain bins. However, it is uncommon to “flex” more than a small distance either side of the nominal bin location because of the bin smear that would be associated with collecting traces from further away, and such “flexing” is usually based on a rectangular bin criteria.

It is known in the art to perform migration on seismic data prior to stacking. See, for example, U.S. Pat. No. 6,826,484 issued to Martinez et al. In a prestack migration sequence, each trace to be processed is migrated using its actual location (not the average of a stack set, or a theoretical bin center). Trace locations may be output from the migration stage at any selected location, and such locations are generally positioned on a grid which is associated with bin centers. The output traces can then be stacked. Despite the change in processing methodology from post stack migration, the traces selected for processing, and the methods of infill selection used in the industry, have remained the same.

There exists a need to evaluate the quality of seismic data acquisition that is more well suited to prestack migration processing methods.

### SUMMARY OF THE INVENTION

One aspect of the invention is a method for assessing data coverage in a three dimensional marine seismic survey. A method according to this aspect of the invention includes determining at least one Fresnel zone for one or more seismic data traces. A contribution is determined for each of the seismic data traces to each one of a plurality of bins in a predetermined pattern. Each contribution is based on the Fresnel zone associated with each seismic data trace. The contributions from all seismic data traces contributing to each bin are summed. The summed contribution for each bin a is stored or displayed and the summed contributions in each bin are compared to a selected threshold to determine coverage.

A method for marine seismic surveying according to another aspect of the invention includes towing a plurality of seismic sensors in a body of water. A seismic energy source is actuated in the body of water at selected times. Seismic signals are detected at the seismic sensors resulting from the actuation of the seismic energy source.

A seismic data trace is created for each of the detected signals. At least one Fresnel zone is determined for one or more seismic data traces. A contribution is determined for each of the seismic data traces to each one of a plurality of bins defined in a predetermined pattern. Each contribution is based on the Fresnel zone associated with each seismic data trace. In each bin the contributions from all seismic data traces contributing to each bin are summed. The summed contribution in each bin is compared to a selected threshold to determine coverage.

Other aspects and advantages of the invention will be apparent from the following description and the appended claims.

### BRIEF DESCRIPTION OF THE DRAWINGS

FIG. 1 shows a plan view of an example of acquisition of marine seismic data.

FIG. 2 shows a vertical section corresponding to the plan view of FIG. 1.

FIG. 3 shows examples of trace impulse response for migration for various flat reflectors in the subsurface.

FIG. 4A shows an explanation of determining the size of a Fresnel zone where a seismic source and a seismic receiver are collocated.

FIG. 4B shows an explanation of determining a Fresnel zone where the source and receiver are offset from each other/

FIGS. 5A through 5E illustrate binning seismic data by individual traces, with an overlay of a Fresnel zone (FIGS. 5A and 5C) for comparison.

FIGS. 6A and 6B illustrate binning seismic data by contribution of multiple traces each having a determinable Fresnel zone.

### DETAILED DESCRIPTION

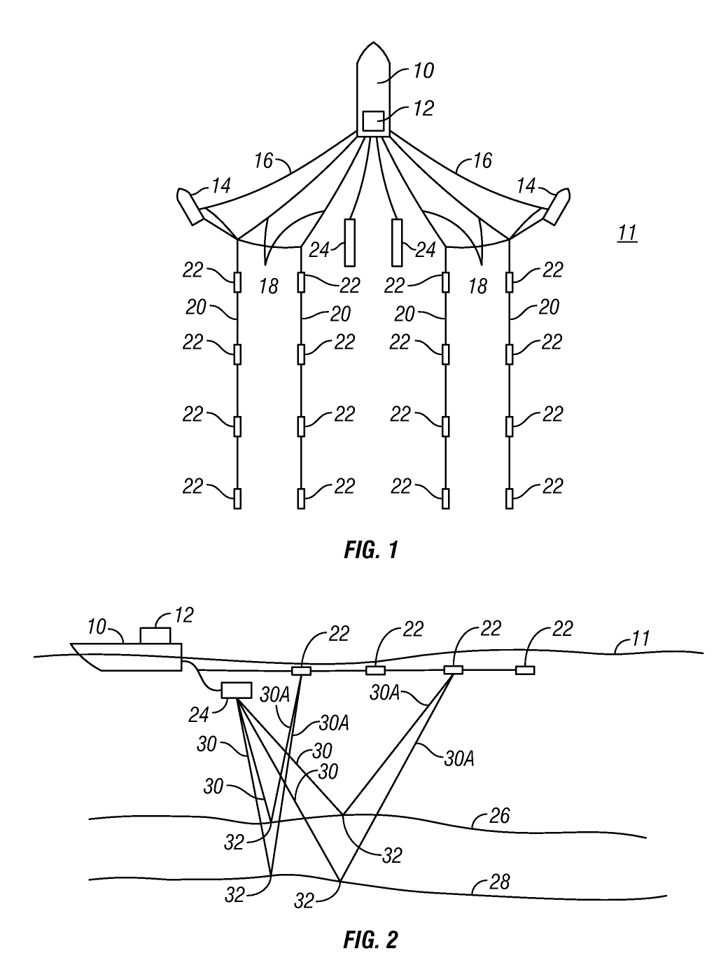

FIG. 1 shows a plan view of an example of acquiring three dimensional (“3D”) marine seismic data. A seismic survey vessel 10 may include certain equipment, referred to collectively as a “recording system” 12. The vessel 10 moves in a selected direction along the surface of a body of water 11 such as a lake or the ocean. The recording system 12 may include certain devices (none shown separately) for: navigation, including determining the position of the vessel 10 and the various devices (explained below) towed in the water 11 by the vessel 10; for actuating one or more seismic energy sources 24 towed in the water 11 and for recording signals generated by each of a plurality of seismic sensors 22 in response to energy imparted by the sources 24.

The seismic sensors 22 are typically pressure gradient responsive sensors such as hydrophones, although the type of sensor is not in any way a limit on the scope of the present invention. The sensors 22 are longitudinally distributed along cables called streamers 20 that are towed in the water 11 by the vessel 10. The acquisition example shown in FIG. 1 includes a plurality of streamers 20 towed in parallel behind the vessel 10. Equipment used to maintain the streamers 20 in a selected lateral relationship with respect to each other include paravanes 14 disposed at the end of ropes 16. The paravanes 14 provide a selected lateral component of force, transverse to the direction of motion of the vessel 10, to cause lateral separation of the streamers 20. The forward end of each streamer is coupled to the vessel 10 through a “lead in” cable 18.

At selected times, the one or more seismic energy sources 24 is actuated, and signals detected by the various sensors 22 are recorded by the recording system 12. The position of the sources 24 and the sensors 22 are determined at the times of actuation of the sources 24. Devices used for determining such positions are known in the art. See, for example, U.S. Patent Application Publication No. 2007/0091719 filed by Falkenberg et al. The positions of the sources and sensors are used to locate both the signal data acquired by the seismic survey and the results obtained by interpretation of the signal data.

The one or more seismic energy sources 24 may be air guns, water guns, arrays of such guns, marine vibrators or any other seismic energy source known in the art. The number of streamers, the number of and types of seismic energy sources and the configuration of the foregoing are not intended to limit the scope of the invention.

The example of seismic data acquisition shown in FIG. 1 is shown in cross section in FIG. 2 to illustrate the basis of a geometric definition used in the description of the present the invention. When the seismic energy source 24 (only one shown in FIG. 2) is actuated, seismic energy propagates outwardly from the source 24, some of which moves downwardly through the subsurface to acoustic impedance boundaries 26, 28 located in rock formations below the water bottom. Such energy is shown generally by ray paths at 30. When seismic energy is reflected from the boundaries 26, 28, it travels upwardly until it is detected by the sensors 22. Such upwardly traveling energy is shown generally along ray paths 30A. At each position at which the source 24 is actuated, and for each corresponding seismic sensor position, there is a position in the subsurface, these positions shown generally at 32, which may be considered a reflection point. Each reflection point 32 will typically be located at one half the distance (offset) between the source 24 and the particular seismic sensor 22 at the time of source actuation and recording of the detected signals. Thus, a set of reflection points may be defined based on the positions of the source 24 and the sensors 22 for each actuation of the source 24.

The cross section shown in FIG. 2 includes only one streamer and one seismic energy source for clarity of the illustration, however the principle is applicable to any number of seismic energy sources and seismic sensors.

A result of the acquisition arrangement shown in FIG. 2 is that for each actuation of the seismic energy source, a plurality of seismic signal recordings is generated. Each such signal recording may include reflective events that correspond to the series of acoustic impedance boundaries at the midpoint between the position of the seismic source and the position of the sensor at the time of actuation of the seismic source. Thus, for a single actuation of the source, a plurality of signal recordings is generated, with each recording corresponding to boundaries at the midpoint between the source and the sensor. As will be appreciated by those skilled in the art, as the vessel moves along the water and the source is repeatedly actuated, successive signal recordings will be made that correspond to essentially the same midpoint as in prior recordings, the difference between successive recordings being the distance (“offset”) between the seismic source and the sensor. In a typically seismic survey, therefore, a plurality of different offset signal recordings correspond to the same position in the survey area. If a system such as the one shown in FIG. 1 is used, such offsets may be defined both along the direction of motion of the survey vessel and perpendicular to the direction of motion. A set of survey positions may be defined based on the approximate position of the mid points determined as shown in FIG. 2. The survey area is usually defined by a grid of rectangular “bins”. For each such bin, a set of data “midpoints” may defined based on offset.

As explained above in the Background section herein, in seismic survey acquisition techniques known in the art, it is believed that good survey results are obtained by operating the vessel and the streamers such that the reflection points 26, 28 are as uniformly spaced as practicable, and that inadequate imaging or “coverage” of features in the subsurface may result if the spatial density of the reflection points is irregular or below a selected threshold based. Using the above explanation of bins, prior art techniques provided that a selected number of data traces were required to be assigned to each bin associated with a particular survey position. Using prior art data quality evaluation techniques, it was believed that absence of sufficient numbers of traces in certain bins was justification for infill shooting.

Each seismic data “trace” (“trace” being the term known in the art for a graphic or other representation of a recorded or interpreted seismic signal) that is input to prestack migration techniques for seismic interpretation, however, contributes to a plurality of output traces from the migration procedure. In migration, the output traces are caused to correspond to selected survey positions such as those defined above with reference to FIG. 2. Because of such contribution to multiple output traces of each input trace, it has been determined that sufficiency of data coverage may not necessarily require sufficient numbers of traces corresponding to each of a plurality of predefined bins.

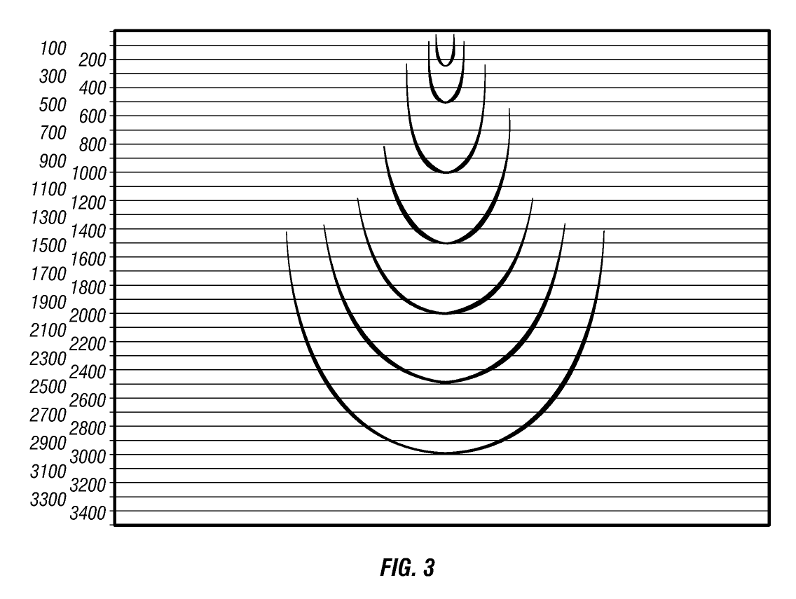

An explanation of methods according to the invention begins with reference to FIG. 3, which shows a typical 2D migration impulse response. Such response is shown in the form of possible reflector positions in the subsurface. Note that the impulse response is wider at longer travel times through the subsurface. At the base of each impulse response, a single trace contributes energy to several adjacent traces, and when a plurality of traces is summed in the output from migration an improved image will result. The traces which contribute to the image of a substantially flat reflective event (i.e., the base of the migration response) fall in an area that can be defined mathematically as the Fresnel zone. If the Fresnel zone is relatively large, there is little difference between the contribution to a migration output of a trace which is disposed exactly in the center of the Fresnel zone, and a trace which is slightly offset from the center. In methods according to the invention, the size of the Fresnel Zone can be the basis for assessment of the sufficiency of coverage of seismic data.

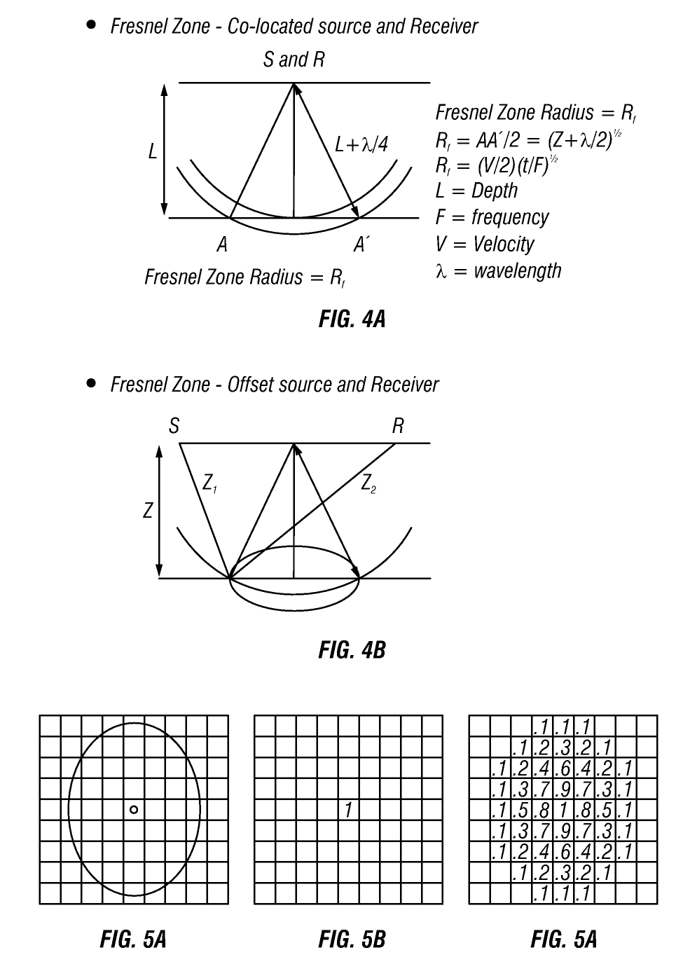

FIG. 4A shows an explanation of the expected size of the Fresnel zone depending on the frequency of the seismic energy detected from a particular subsurface reflector, the seismic velocity and the two-way travel time of the seismic energy to the particular reflective horizon in the subsurface. The equation shown in FIG. 4A may be used for the case of a seismic source and seismic receiver being collocated to estimate the size of the Fresnel zone for each reflective horizon in each trace acquired during a seismic survey. It should be emphasized that FIG. 4A only illustrates the Fresnel zone for a situation where the source and receiver are collocated on the surface. While it is common practice for this to be used as a definition of the Fresnel zone, it is possible to compute Fresnel zone shapes and sizes for the more common situation where the source and receiver are not located at the same point (they are offset), and these Fresnel zones are larger and elliptical. It is important in practical implementations of the present invention that offset Fresnel zones are used. One equation that defines the shape of such Fresnel zone is as follows:

$$\frac{{x}^{2}}{{L}_{1}^{2} - {z}^{2} - {h}^{2}} + \frac{{y}^{2}}{{L}_{1}^{2} - ( \frac{{L}_{1}^{2} {z}^{2}}{{L}_{1}^{2} - {h}^{2}} )} = 1 \qquad ( 1 )$$

wherein
x=radius of ellipse in the direction perpendicular to shot receiver azimuth.
y=radius of ellipse in the direction parallel to shot receiver azimuth.
h=half the receiver offset (source to receiver distance=offset/2)
z=depth to the horizon.
L₁=0.5(2L+ΔL)
L=one way ray path distance (=\sqrt{h²+z²})
ΔL=half wavelength=v/(2f)
v=velocity
f=frequency

Once the Fresnel zone size has been determined, a weight function may be defined based on the distance from the position corresponding to the particular recorded data trace used. The weight function may be set to unity or other convenient value at the position of the data trace (the center of the Fresnel zone) and may decrease to zero at the outer limit of the Fresnel zone. The Fresnel zone for each input data trace for each reflective horizon may be overlaid on a grid of the output bin locations. A weighted trace amplitude value may be defined for each trace for each bin based on the distance between the center of each bin and the center of the Fresnel zone for each data trace. For each bin, the weighted trace amplitudes are summed for all traces whose bin centers are within Fresnel zones of each data trace for each such reflective horizon. For each bin having a summed weighted trace amplitude exceeding a selected threshold, such bin may be deemed to have sufficiently dense seismic data coverage to avoid spatial aliasing in an output image trace corresponding to that particular bin.

In some examples, the weighted trace amplitude for each bin may be determined during seismic acquisition operations, such as explained above with reference to FIG. 1. In such examples, the weighted trace amplitude values may be stored or displayed in one or more devices forming part of the recording system (12 in FIG. 1), so that an evaluation of whether and to what extent infill seismic acquisition may be required for adequate data coverage.

The thresholds selected for the assessment of coverage based on Fresnel zones will be related to the amplitude of the final image (that is, the image made by migration) of the seismic data at any particular image output or bin center location. The foregoing is not true of current methods of seismic coverage assessment where a completely empty bin (no traces), deemed to represent inadequate coverage, may still have a seismic image after migration.

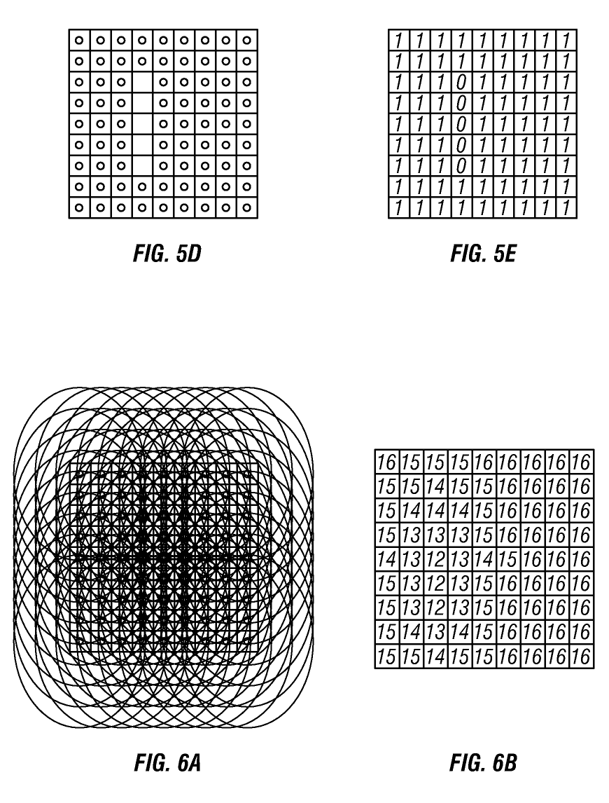

FIGS. 5A through 5E show a set of migration image output bins each associated with a bin center at a predefined position. In techniques for determining sufficiency of data density known in the art prior to the present invention, as explained above, a certain number of input data traces (one or more, depending on bin size and other factors) was required to be associated with each bin in order for the seismic data to be deemed sufficiently dense to properly image features in the subsurface without spatial aliasing. FIG. 5A shows one such output bin approximately in the center of a grid of such bins, typically equal in size and uniformly spaced. An example Fresnel zone for a data trace allocable to the bin is shown by the ellipse in FIG. 5A. In FIG. 5B, a weight for the trace of FIG. 5A is shown as unity for the situation where the geodetic position of the mid point of the source and receiver positions at the time of signal recording is located within the indicated bin. For such situation, the bin including the mid point position is assigned a weight of unity or 100 percent, and other bins are assigned a weight of zero. FIG. 5C shows the bin weight of FIG. 5B for the example trace with an overlay of bin weights calculated according to an example of the invention. The bin weights in FIG. 5C correspond to the Fresnel zone outline shown in FIG. 5A. FIGS. 5D and 5E show bin allocation according to methods known in the art prior to the present invention. For bins in which no data trace has a mid point within the geodetic area defined by the bin, no weight is applied, and as shown in FIG. 5D no trace is allocated to such bin. In determining scope of coverage using the binning shown in FIG. 5D, weight functions shown in FIG. 5E indicate zero weight to the bins having no allocated trace.

FIGS. 6A and 6B illustrate weight function calculation according to an example of the invention. For a seismic system as shown in FIG. 1, each trace may have a Fresnel zone calculated as explained above with reference to FIGS. 4A and 4B. Such Fresnel zones for an example horizon are shown in FIG. 6A superimposed on a bin grid similar to the one shown in FIGS. 5A through 5E. Weigh functions calculated as explained above provide trace amplitude values as shown in FIG. 6B. As can be observed in FIG. 6B, notwithstanding “holes” in the coverage if bin allocation is performed according to prior art methods, the trace amplitude sum value for essentially all bins in FIG. 6B indicate substantial trace amplitude sum values. Accordingly, data coverage may be determined to be adequate using a method according to the invention.

It is well known in the art that imaging of shallow layers or horizons in the subsurface uses seismic traces which have smaller offsets (distance between source position and receiver position), whereas longer offset seismic data is useful for imaging deeper layers in the subsurface. Furthermore, the seismic reflections from shallow depths in the subsurface occur at an earlier time in a seismic record. The size of the Fresnel zone is a function of both seismic travel time and offset, and is smaller at shorter time, and smaller offset. For imaging of very shallow targets, only the shortest offset seismic data at very early time is useful. The Fresnel zone associated with these images is therefore relatively small. An inspection of artifacts associated with Fresnel zone coverage leads to the conclusion that a suitable method for minimizing artifacts in the resultant seismic image is to ensure that the shortest offset seismic data traces (those recorded by receivers close to the vessel) result from the corresponding seismic receivers being positioned as closely as is practicable in a regular grid, that is, as close as possible to the intended receiver positions in a “preplot” survey pattern, and at the center of each of the “bins” defined for the survey. The foregoing conclusion is results from the fact that the Fresnel zones for short offset traces are small and may not overlap or even extend to the edge of a bin. However, precise control of the receiver position for the shortest offset receivers in a seismic streamer is easier than control of longer offsets, because the shortest offset seismic receivers are relatively close to the seismic vessel and are less affected by streamer “feathering” In one example of seismic data acquisition performed to minimize artifacts in the shallowest (nearest offset) images in the seismic data, the vessel should be steered as closely as possible along a line directly over the intended bin locations, and not steered to the side in an attempt to compensate for feather in the streamers. While steering a seismic vessel along a straight “preplot” line is known when it is intended for the source positions to be repeated in a subsequent survey at a later time or date, the foregoing is not common practice for ordinary 3D seismic acquisition. In ordinary 3D acquisition it is common practice to steer the vessel in the opposite direction to the streamer feather to partially compensate for crossline offset in the longer offset receivers. When the vessel is steered directly down the intended path for the vessel without correcting for the crossline offset in the longer offset receivers, then the signals acquired by the shortest offset receivers in the streamers will fit any criteria for coverage, as the midpoint positions for such receivers will be at or very close to the intended midpoint locations. Under these circumstances assessment of coverage may be performed only for those of the longer offsets in the streamers likely to be affected by feathering.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for assessing data coverage in a three dimensional marine seismic survey, comprising:
determining at least one Fresnel zone for at least one of a plurality of seismic data traces;
computing a contribution of each of the seismic data traces to each one of a plurality of bins defined in a predetermined pattern, each contribution based on the Fresnel zone associated with each seismic data trace;
summing in each bin the contributions from all seismic data traces contributing to each bin;
storing and displaying the summed contribution for each bin; and
comparing the summed contribution in each bin to a selected threshold.

2. The method of claim 1 wherein the contribution for each bin is determined by calculating a distance from a position of a midpoint between a seismic source location and a seismic receiver location corresponding to each seismic data trace and a center of each bin.

3. The method of claim 2 further comprising applying a predetermined function to each seismic data trace, the function defining a relationship between the determined distance and a scaling factor.

4. The method of claim 3 wherein the predetermined function has a maximum value at the midpoint determined for each seismic data trace and the predetermined function has a value of zero at an edge of the Fresnel zone corresponding to each seismic data trace.

5. The method of claim 1 wherein a geometry of each Fresnel zone is related to a velocity distribution of subsurface formations and a range of seismic energy frequencies.

6. The method of claim 5 wherein the range of seismic energy frequencies is related to a seismic travel time to a selected subsurface horizon.

7. The method of claim 1 wherein the determining at least one Fresnel zone, computing contribution, summing contribution and comparing are performed during acquisition of seismic data on a seismic vessel.

8. The method of claim 7 further comprising steering the seismic vessel as closely as possible to a predetermine seismic survey path, without modification of vessel trajectory to correct streamer feathering.

9. The method of claim 1 further comprising determining a plurality of Fresnel zones for each seismic data trace, each of the plurality of Fresnel zones for each trace having geometry related to a seismic energy travel time of seismic energy to a selected horizon and a frequency range of seismic energy corresponding to seismic signals related to the selected horizon.

10. A method for marine seismic surveying, comprising:
towing a plurality of seismic sensors in a body of water;
actuating a seismic energy source in the body of water at selected times;
detecting seismic signals at the seismic sensors resulting from the actuation of the seismic energy source;
creating a seismic data trace for each of the detected signals;
determining at least one Fresnel zone for at least one of the seismic data traces;
computing a contribution of each of the seismic data traces to each one of a plurality of bins defined in a predetermined pattern, each contribution based on the Fresnel zone associated with each seismic data trace;
summing in each bin the contributions from all seismic data traces contributing to each bin in the grid;
at least one of storing and displaying the summed contribution for each bin; and
comparing the summed contribution in each bin to a selected threshold.

11. The method of claim 10 wherein the contribution for each bin is determined by calculating a distance from a position of a midpoint between a seismic source location and a seismic receiver location corresponding to each seismic data trace and a center of each bin.

12. The method of claim 11 further comprising applying a predetermined function to each seismic data trace, the function defining a relationship between the determined distance and a scaling factor.

13. The method of claim 12 wherein the predetermined function has a maximum value at the midpoint determined for each seismic data trace and the predetermined function has a value of zero at an edge of the Fresnel zone corresponding to each seismic data trace.

14. The method of claim 10 wherein a geometry of each Fresnel zone is related to a velocity distribution of subsurface formations and a range of seismic energy frequencies.

15. The method of claim 14 wherein the range of seismic energy frequencies is related to a seismic travel time to a selected subsurface horizon.

16. The method of claim 10 further comprising steering a seismic vessel that performs the towing the seismic sensors as closely as possible to a predetermine seismic survey path, without modification of vessel trajectory to correct streamer feathering.

17. The method of claim 10 further comprising determining a plurality of Fresnel zones for each seismic data trace, each of the plurality of Fresnel zones for each trace having geometry related to a seismic energy travel time of seismic energy to a selected horizon and a frequency range of seismic energy corresponding to seismic signals related to the selected horizon.
